(19) United States
(12) Patent Application Publication
(10) Pub. No.: US 2002/0069119 A1
(43) Pub. Date: Jun. 6, 2002

(54) Method and system for interactive real-time creation of printed and electronic media with customized look and feel for individual users

(76) Inventor: Samuel Rogatinsky, Hollywood, FL (US)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 09/729,584

(22) Filed: Dec. 4, 2000

Related U.S. Application Data
(60) Provisional application No. 60/168,575, filed on Dec. 2, 1999.

(51) Int. Cl. G06F 17/60

(52) U.S. Cl. 705/26

(57) ABSTRACT

A method, system and computer readable medium for automated dynamic creation of customized documents and/or electronic media, especially for marketing purposes is provided. Specifically, the invention relates to a system, method, and computer site for generating documents and/or electronic media having a customized look and feel in its use of design elements, physical characteristics, and manner of presentation of images and text to appeal to the individual consumer by interacting with that individual and analyzing the information gathered therefrom.

### CROSS-REFERENCE TO A RELATED APPLICATION

This application claims the benefit of U.S. Provisional Application No. 60/168,575, filed Dec. 2, 1999, which is incorporated herein by reference.

### FIELD OF THE INVENTION

The present invention relates to automated dynamic creation of customized documents and/or electronic media, especially for marketing purposes. Specifically, the invention relates to a system, method, and computer site for generating documents and/or electronic media having a customized look and feel in its use of design elements, physical characteristics, and manner of presentation of images and text to appeal to the individual consumer by interacting with that individual and analyzing the information gathered therefrom.

### BACKGROUND OF THE INVENTION

Many products and services are advertised and/or presented to consumers with preprinted marketing literature such as brochures, pamphlets, and advertisements (in printed form or electronic media). This marketing literature contains information about the product or service presented in a manner determined by marketing and other factors to influence a consumer into making a decision regarding whether to purchase the product or service. Such marketing factors necessarily influence the chosen style, image, and manner of presentation of the literature (e.g., paper type, text font and size, color combination, texture, photographs, arrangement, and the like). For example, marketing experts have determined that sports car literature should be presented on glossy paper using dominant colors such as red and black, whereas, real estate literature should utilize a “soft sell” with pastel colors on mat paper.

Since manufacturers and other product or service providers generally design and print only one version of a brochure for a specific product or service (or one catalog for a series of products/services), this one brochure/catalog is designed to target the broadest range of prospective consumers in a positive manner, often using generalities of the market. However, as with most generalities, there are numerous exceptions. Therefore, a number of potential consumers are not persuaded by the brochure or are even negatively influenced by it.

Previously, marketing data was collected when the consumer filled out warranty cards or answered survey questions. Recently, global networks such as the Internet/World Wide Web have provided new methods for collecting consumer marketing information. For example, various Internet services monitor the Internet's activities compiling statical data, stored in databases, enabling businesses to better reach the consumer. Examples of such Internet services include eMarketer.com and CyberAtlas.internet.com which collect information (demographics, usage, buying habits, trends) and maintain vast databases containing global market information and provide such information in statical reports. Businesses can use these databases to design their marketing plans to be consistent with their desired market.

Other Internet companies, such as DataSage.com, Mannalnc.com, and RightPoint.com provide real-time personalized emarketing to personalize customers' online experience with specifically directed content, promotions, and the like. In particular, DataSage, Inc., for example, focuses on capturing customer transaction and click-stream data and analyzing that data with individualization software (DataSage netCustomer™) so companies can individualize customer promotions and web site content based on customer preferences. The software recommends the best combinations of products, prices and information for each customer to provide direct promotions, cross-selling, and up-selling. Manna Inc.'s FrontMind™ software is a proprietary real-time learning and inference technology which provides a personalized experience for online customers. Similarly, RightPoint, Inc. provides highly targeted and personalized real-time product recommendations, promotions and loyalty offers for their web sites and email campaigns.

A number of patents also describe various types of dynamic and interactive creation of documents, products and information which allow variable content, such as U.S. Pat. No. 5,765,142 to Allred, U.S. Pat. No. 5,990,885 to Gopinath, U.S. Pat. No. 5,835,236 to Barbari, U.S. Pat. No. 5,615,342 to Johnson, U.S. Pat. No. 3,982,744 to Kraynak, U.S. Pat. No. 5,114,291 to Hefty, U.S. Pat. No. 5,758,328 to Giovannoli, U.S. Pat. No. 5,765,874 to Chanenson, and U.S. Pat. No. 5,740,425 to Povilus, each of which is incorporated herein by reference. Patents also exist which model user's preferences utilizing various algorithms and known techniques, such as U.S. Pat. No. 5,799,298 to Bingham, U.S. Pat. No. 5,987,415 to Breese, and U.S. Pat. No. 5,550,746 to Jacobs, each of which is incorporated herein by reference.

Although a number of the above-noted systems allow for some interactive analysis and variation/customization of content, none of the above-noted systems provide analysis of behavior and personality to customize the “look and feel” of printed or electronic media to appeal to the individual user.

### BRIEF SUMMARY OF THE INVENTION

The present invention solves the above-stated problems in the art by providing a system, method and computer site for obtaining real-time information from individual consumers, analyzing that information via various algorithms, behavioral profiling, pattern recognition, learning algorithms, real-time learning and inference technology and providing a real-time report that will generate printed or electronic media with customized design elements, physical characteristics and manner of presentation of text, graphics and images (i.e., look and feel) tailored to that individual. The resulting media is designed to entice and attract the consumer through individualized visual and/or tactile characteristics which most closely represent that consumer's personality profile as determined by the analysis.

The invention can be implemented in numerous ways, including as a system, a method, a computer site, or a computer readable medium. The invention preferably relies on a communications infrastructure, for example the Internet, wherein customer interaction is possible. Several embodiments of the invention are discussed below.

As a computer system, an embodiment of the invention generally includes a database of statistical consumer marketing data and a processor unit. The processor unit operates to receive information from a consumer interacting with the system (preferably through a series of questions and answers via a global communication network/Internet application or through analysis of the consumer's online activity, such as purchase transactions, click-stream history, and the like) and to analyze the received information in conjunction with the statistical information (e.g., consumer habits, marketing trends, predictions, styles, preferences) to generate marketing media with a customized “look and feel” which appeals to that individual. This customized “look and feel” is found in the chosen design elements, physical characteristics and manner of presentation of text and images of the media, including but not limited to fonts, colors, text/image/graphics and ratio thereof, paper type, illustrations, layout, and other visual/tactile characteristics of the media. The marketing media may include print or electronic media.

Print media is preferably dynamically generated by digital variable printing software/machines, such as those devices well known in the art produced by Agfa, IBM, or Xerox. This type of software drives the digital printing machine to accept collected data to output a digital variable data print job. The variables (fonts, color, layout, images, illustrations, and the like) are placed in the appropriate location on the brochure and the brochure is printed and mailed to the consumer. Other devices are also suitable for producing printed media in accordance with the invention such as software controlled laser/ink jet printers, color copiers, printing machines, and the like.

For electronic media, for example, the processor preferably accesses the database to retrieve the customized media and then sends the data in the form of an HTML page to a web server, which delivers the HTML page over the Internet to the consumer's web browser software, which will display the marketing literature on the consumer's display device. Electronic media may also be transmitted by other well known techniques such as email, interactive television, and the like.

As an online method and a computer (web) site, with statistical data being obtained from a database(s) of marketing information associated with the computer system, an embodiment of the invention includes: interacting with a consumer to obtain answers to specifically directed questions (or via software analysis of online activities) which reveal the individual's preferences/style, storing the answers in a first database as raw data, processing that data in conjunction with a statistical marketing database(s) utilizing predetermined computer algorithms or other analyzing means, and generating printed or electronic marketing media customized to appeal to that consumer. The computer site is preferably viewed with a client web browser as an HTML document through a web secure server communicating with an application server having a database associated therewith.

As a computer readable medium containing program instructions for marketing media generation, an embodiment of the invention includes computer readable code devices for interacting with a consumer as noted above, processing that data in conjunction with a statistical marketing database, and generating unique printed or electronic marketing media customized to appeal to that consumer.

The advantages of the invention are numerous. One advantage of the invention is that a business is able to send information about a particular product or service in a form which is more pleasing to an individual consumer's preferences. As a result, the consumer is more likely to make a positive purchasing decision increasing the rate of response. The invention eliminates the requirement for businesses to generalize marketing literature. Instead, businesses can get direct input and feedback from individual users and will ultimately increase sales by marketing to an audience of one. This type of product will lead to savings in printing costs since brochures need only be sent to those who request them, and such brochures will be tailored to that individual increasing the possibility of responses/sales. Storage issues are also addressed since brochures will be printed on demand.

Other aspects and advantages of the invention will become apparent from the following detailed description taken in conjunction with the accompanying drawings, illustrating by way of example the principles of the invention.

All patents, patent applications, provisional applications, and publications referred to or cited herein, or from which a claim for benefit of priority has been made, are incorporated herein by reference in their entirety to the extent they are not inconsistent with the explicit teachings of this specification.

### BRIEF DESCRIPTION OF THE DRAWINGS

FIG. 1 is a block diagram of the software control of a preferred example of the present invention.

FIG. 2 is a block diagram of the preferred hardware components of the present invention.

### DETAILED DISCLOSURE OF THE INVENTION

The present invention solves the problems in the art by providing a system, method, and computer site for generating media customized to appeal to an individual by interacting with that individual and analyzing the information gathered therefrom via a computer, preferably over the Internet. Individuals preferably participate with this system via a computer terminal, web-enabled television system, or other suitable access device designed to access a computer site operating according to the present invention.

The method of the present invention comprises maintaining a computer database of statistical information and solicited/unsolicited consumer information for analysis. Analytical methods are used to correlate the consumer information with the statistical information to report information (and predict) which is utilized to customize and generate the media having an individualized “look and feel.” The invention operates as a computer site or in conjunction with an established computer site which comprises at least one web server computer designed for serving a host of computer browsers.

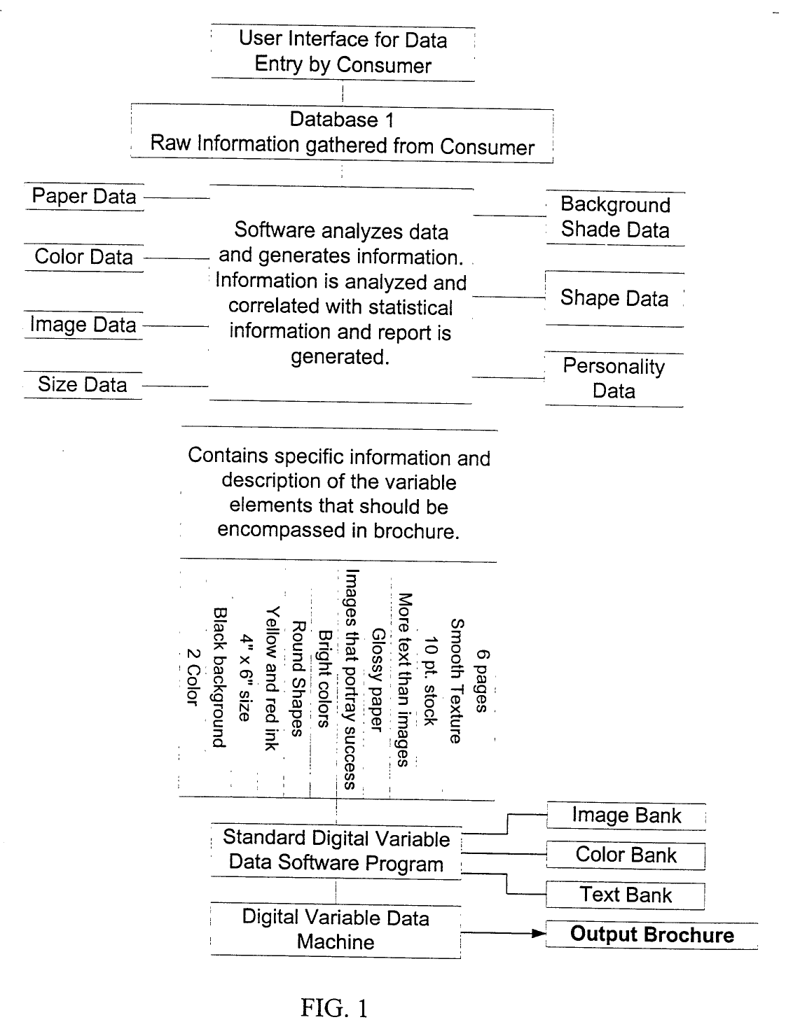

In a preferred embodiment, the present invention operates similar to standard e-commerce sites (or in conjunction with such sites) with the exception of having the additional unique features of the invention. Preferably, the invention is operated as or in conjunction with an interactive web site. The typical operation of the web site from a consumer's point of view will now be explained in detail with reference to FIG. 1.

Initially, an Internet user (consumer) logs onto a site and answers a series of questions posed to the user either on one page or a series of questions on many different pages throughout the web site. Questions may be text entry fields, “yes” or “no” questions, true/false, selection from a list of possible answers (multiple choice), or they may ask the user to choose between two or more paths, with each path signifying an important answer. Information may also be gathered from known Internet information gathering techniques and Web-analysis tools, such as “cookies,” browser histories, and the like. Preferably the site analyzes all answers to questions posed, all points of interaction, customer profiles, content response, ad response, e-mail, purchase data, click paths through web pages, customer transaction data, cookies, click stream, when and where a user enters, what the user views, time spent viewing, where the user goes and where the user has been.

The questions may be generic/standard marketing questions utilized to illicit information or may be written for a consumer in a specific industry with assistance from the marketing department of a particular company. The questions that are asked and answered are important as they form the basis of the analysis that will ultimately determine what type of printed product will be produced for the consumer. Final selections for the brochure will be made in response to the consumer's answers and online activity. The printed products are preferably produced utilizing known digital variable printing techniques.

The individual consumer's answers and information regarding online activity are entered into a storage means such as a database, array or record that records all responses and movements, i.e., click stream, and a record is created for each consumer with the information that was gathered on the web site. These answers form the raw data acted upon and analyzed by the system.

This raw data (consumer information) is analyzed and correlated with stored statistical information stored (e.g., in separate databases). The system preferably utilizes various algorithms, real-time learning and inference technology, behavioral and personality profiling, pattern recognition learning algorithms, neural networks, and the like in order to correlate statistical information with user responses. The necessary statistical information can be gathered from various known sources or acquired and continuously updated as the interactive web sites collect information from each new user. Sources of marketing information include eMarketer™ which provides analysis, statistical estimates, projections and long-term trends for the market and CyberAtlas™ which provides statistics and Web marketing information.

Examples of data gathering, analysis, and modeling (data mining) can be found in various software packages and techniques, such as DataSage's netCustomer™ and are well known in the art. Online Analytical Processing (OLAP) and data mining are also known software solutions that support marketing automation and analysis. OLAP views data in a multidimensional format to rapidly manipulate and query large volumes of information allowing viewing of data in meaningful patterns. Relational OLAP middleware solutions are also available. Data mining software automatically reads through data and discovers important relationships within information that may not be intuitive or obvious, giving a more focused base of knowledge on which to perform analysis and prediction.

Preferably, the databases which store the statistical information contain information related to the following variables which appeal to and affect consumers in different ways: colors, images, illustrations, fonts, paper type (mat or glossy), image size, tendency of a particular user to read text rather than glance at images, tendency to glance at images rather than read text, tendency to review a larger size brochure or smaller size brochure, tendency to read a 2-page brochure rather than a 6-page brochure (i.e., does this person's profile indicate that he/she will spend the time to read a lengthy brochure or document), shapes that are most appealing, color of paper, color of ink to be used on the paper, whether a one or two color brochure sufficient for this individual or whether this individual responds better to a four-color process flashy brochure with dull or spot gloss varnish, heavy paper or light paper, type of images that are most appealing (i.e., does the subject profile indicate that he/she has an expensive lifestyle and wants to see images which reflect the same). All or some of the above factors are applied to decisions regarding generating the look and feel of the print or electronic media and will be correlated with the information that was gathered initially in the first database.

In addition to applying the information about the specifications that will be most effective for media, based on the answered questions, the present invention will analyze and predict in real-time the behavior and what type of personality the consumer has and, based on its conclusion, will recommend the type of images and above criteria to be utilized for the look and feel of the media.

Since there endless amounts of images available to insert into media, the images are preferably broken down into categories and subcategories so that certain images are chosen based on the predictions and recommendations made by the software of the present invention.

For example, for a financial or investment company, its web site(s) will gather information about its users. A certain user's answers will indicate that the user is, for example, willing to assume greater risk. Based on this information, the present invention determine's the user's lifestyle by analyzing answers to specifically directed queries and online activity and processing this information in conjunction with stored statistical information based on predetermined algorithms. In this example, the invention determines that this type of user should receive a brochure which reflects his fast-paced, risk taking, lifestyle, i.e., the style, format and presentation of the brochure (images, font, colors, and the like) are manipulated to best appeal to that user's lifestyle. To achieve this, for example, the images used in the brochure will be daring and exciting as opposed to being boring and conservative.

In a preferred embodiment, the image bank for a certain industry will have categories for its photos, for example, exciting, conservative, undecided, inexperienced investor. There will be numerous photos in each of the categories. Subcategories may also be established based on further groupings/divisions, e.g., male/female, single/married/divorced/married with children, homeowner/renter, student/professional/retired/military. The categories will be established by the company and placed in variable databases. The image that a particular user receives in his/her brochure will be driven by the analysis of the information gathered in the consumer information database.

The software will take into consideration a number of general factors, including but not limited to, age, sex, race, socioeconomic status, as well as industry specific information. Accordingly, not all questions asked of the user will be the same for each industry. Specific industry information will be gathered for various sources (research, literature, customer databases, company preferences, and the like) to formulate the appropriate questions to be asked on the users when interacting with the web site.

After the software of the present invention analyzes the information, the next step in the process is to generate in real-time a report which provides the specifications to be utilized for the look and feel of the media. The software generates a detailed description of the variable elements that should be encompassed in the media for the particular individual.

For example, based in the information that was gathered, after analyzing the information and predicting what type of brochure a particular individual should receive, the system would direct the database to generate a brochure with the following variable information: background=red with full coverage, size=4×6 with 2 pages, paper=glossy, images bright, exciting, daring, portray success, shapes=round, colors used=4, format=more images than text, cover stock=10-point cover.

The selected variable information is then sent to the digital variable data printing software (e.g., Agfa's Personalizer X, IBM, infoprint, Xerox). These digital variable print machines accept the selected data in order to output a unique digital variable data print job in accordance therewith. The variables are placed in their appropriate location on the brochure and the custom brochure is printed and sent to the user.

The variable information may also be used to create a custom electronic brochure which is provided to the individual user as an HTML page, e-mail attachment, or the like.

Moreover, as the information is collected, the interactive web site will also begin to automatically reflect the user's preferences. For example, the next page visited will reflect the look and feel (e.g., colors and images) that are appropriate for the user based on the analysis of the collected data.

An advantage of this invention is that the end product is a true reflection of what that person responds to best. Every element of the media is there because the invention analyzed the type of person requesting the information, resulting in a higher response rate. This necessarily results in increased sales since the company is directly marketing to an audience of one.

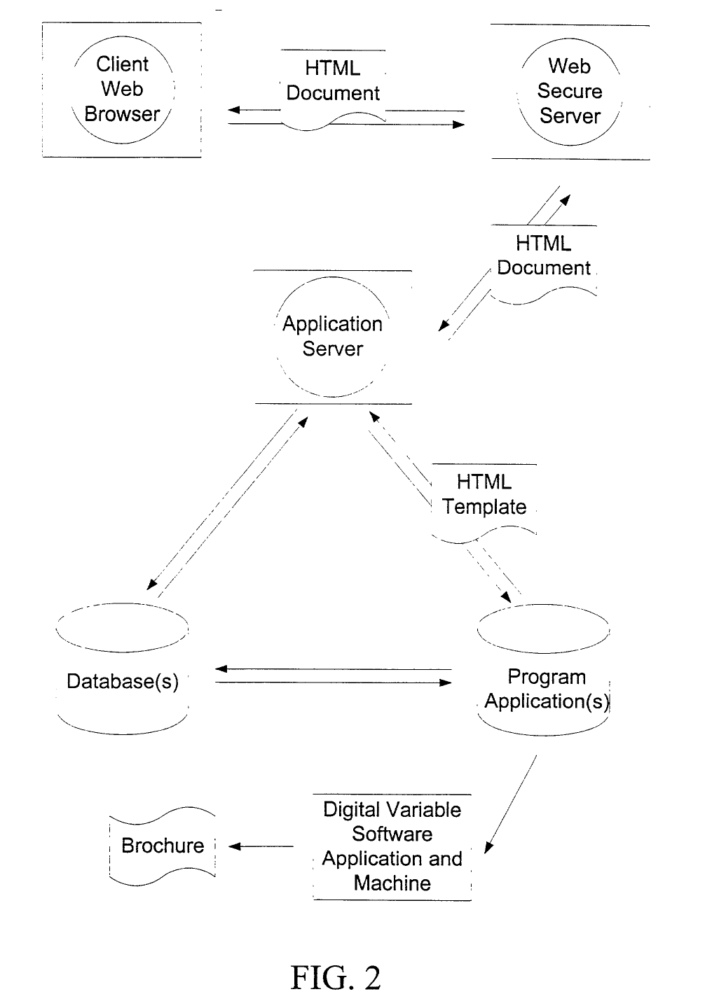

FIG. 2 is an overview of the preferred embodiment of the hardware architecture for the present invention. The architecture preferably comprises at least two networked computer processors (client component and server component(s)) and a database(s) for storing consumer data, statistical data, variable data (color, size, text, layout, images) and static brochure data (non-variable brochure content and product information). The computer processors can be processors that are typically found in personal desktop computers (e.g., IBM, Dell, Macintosh), portable computers, mainframes, minicomputers, or other computing devices. Preferably in the networked client/server architecture of the present invention, a classic two or three tier client server model is utilized. Preferably, a relational database management system (RDMS), either as part of the Application Server component or as a separate component (RDB machine) provides the interface to the database.

In a preferred database-centric client/server architecture, the client application generally requests services from the application server which makes requests to the database (or the database server). The server(s) (e.g., either as part of the application server machine or a separate RDB/relational database machine) responds to the client's requests.

More specifically, the client components are preferably complete, stand-alone personal computers offering a full range of power and features to run applications. The client component preferably operates under any operating system and includes communication means, input means, storage means, and display means. The user enters input commands into the computer processor through input means which could comprise a keyboard, mouse, or both. Alternatively, the input means could comprise any device used to transfer information or commands. The display comprises a computer monitor, television, LCD, LED, or any other means to convey information to the user. In a preferred embodiment, the user interface is a graphical user interface (GUI) written for web browser applications.

The server component(s) can be a personal computer, a minicomputer, or a mainframe and offers data management, information sharing between clients, network administration and security. The Database Server (RDBMS—Relational Database Management System) and the Application Server may be the same machine or different hosts if desired.

The present invention also envisions other computing arrangements for the client and server(s), including processing on a single machine such as a mainframe, a collection of machines, or other suitable means. The client and server machines work together to accomplish the processing of the present invention.

The database(s) is preferably connected to the database server component and can be any device which will hold data. For example, the database can consist of any type of magnetic or optical storing device for a computer (e.g., CDROM, internal hard drive, tape drive). The database can be located remote to the server component (with access via modem or leased line) or locally to the server component.

The application server provides specific output data to a digital variable printer machine to prepare custom printed media in real-time. It also provides output to the client component to modify the user interface and to provide appropriate electronic media (e.g., electronic brochures) to individual users.

Following are examples which illustrate procedures for practicing the invention. These examples should not be construed as limiting.

### EXAMPLE 1

### Scenario

Jane Doe logs on to the General Motors web site and begins to research about the car of her dreams. As Jane navigates through the site she begins to respond to questions about many different topics. In addition to personal information, Jane is asked strategically placed questions that have nothing to do with the prospective car but are very significant to the present invention in order to determine the look and feel of the brochure that Jane will receive.

A. Gathering Information

At first Jane is asked the following simple questions about herself:

How old are you?

What part of the country or world do you live in?

Do you like cars or trucks?

What is your dream car?

How many children do you have?

Are you married?

What type of car does your husband drive?

What was the last car you rented?

Then the system asks the following other questions, which are not necessarily related but are nonetheless significant:

Do you enjoy skiing?

Would you take your new car on camping trips?

Would you be interested in the road safety plan or would you fix your car yourself if you had a flat tire?

How far is your home from work?

What type of work do you do?

Where do you enjoy taking your children?

The questions may be on one page or they may be on a number of different pages and other questions may appear based on the answers given to the previous question.

If Jane says she likes skiing, the next question might be, “Would you use your car to drive to your next vacation?”.

The system also utilizes software to determine Jane's click stream and the most recently visited sites and other online activity.

B. Analysis

After the answers and online activity are recorded and placed in the database, the software of the present invention begins to analyze the data and correlates it with statistical information that has been gathered by psychologists and researchers or otherwise.

C. Output

The software of the present invention completes its analysis and generates a report that reads as follows:

Jane should receive a brochure that has the following elements:

1. Color Green and White should be prevalent

2. Adventure images should be prevalent

3. Brochure should have more text than images and text should be the plain language version

4. Brochure should be 8 by 10

5. Paper should be dull

6. Picture of green Chevy Blazer

D. Brochure

A customized brochure is generated in real-time utilizing digital variable printing techniques which has the “look and feel” listed in the above-noted report and mailed to Jane. An electronic version of the brochure is also e-mailed to Jane at her request. The next time Jane logs onto the web site, the site itself has been modified to exhibit a similar “look and feel” which has been previously determined by the invention to appeal to Jane.

### EXAMPLE 2

### Scenario

John Smith logs on to the Expedia.com web site in order to research the possibilities for his upcoming honeymoon. John is very anxious and wants everything to go perfect so he is ready to enter as much information as needed to get the best advice and information. The questions that are posed to John are very direct as he has an interest in providing the information.

A. Gathering Information

The following questions are posed to John:

What is your name?

How old are you?

When was the last vacation you took?

Do you like warm or hot climates?

Is this our first marriage?

How many times have you been married?

What region of the world would you like to visit?

What country are you most interested in visiting?

Do you like to travel in groups?

What part of the country do you live in?

Do you like to live in your city?

The system also utilizes software to determine online activity.

B. Analysis

After the questions are answered, the software of the present invention analyzes the information and generates a report that is based on the correlation of statistical information and information provided by John.

C. Output

The software generates a report in real-time with predictions and indicates that the brochure John receives should have the following elements:

1. Paper should be glossy

2. Brochure should have lots of bright and colorful images

3. More images that text

4. Image of blue sky

5. Images of women man and woman lying on sandy beach

6. Brochure should be 8 by 10

7. 4 page brochure

8. Choose images from large image database

D. Brochure

A customized brochure is generated in real-time utilizing digital variable printing techniques to comply with the above-noted report and mailed to John.

### EXAMPLE 3

### Scenario

Sam Sportsfan logs on to the sportsline.com web site and begins to navigate to the golf section. Sam is very interested in golfing and likes to know who is playing where and when. Even though this is not a retail site, sportsline.com is interested in developing user profiles so that they can actively market to individual users.

A. Gathering Information

As Sam is navigating, the following various questions are asked sporadically.

What is your favorite type of club?

How often do you golf?

Are you married or single?

Does your wife play golf with you?

How long do you usually play golf?

What is the most you've spent on a golf outing?

Do you play in tournaments?

How much did you spend on your clubs?

What is the most expensive club you have given to someone as a gift?

What is the most expensive club you own?

Do you play golf when you are on vacation?

B. Analysis

After the information is entered into the database, the software analyzes the data and generates a report based on statistical data that has been gathered by researchers.

C. Output

The software then generates a report with the following variable elements that should be placed in the users brochure.

The brochure should have the following elements:

1. Use only two colors for brochure

2. Colors are green and brown

3. More text than images

4. Images should be taken from conservative database

5. Size of brochure should be 9 by 12

6. Paper should be textured

7. Paper color should be tan

8. Use technical language

D. Brochure

A customized brochure is generated in real-time utilizing digital variable printing techniques to comply with the above-noted report and mailed to Sam; Sam is also directed to a custom generated web page which follows the same image as the brochure.

It should be understood that the examples and embodiments described herein are for illustrative purposes only and that various modifications or changes in light thereof will be suggested to persons skilled in the art and are to be included within the spirit and purview of this application and the scope of the appended claims.

I claim:

1. A method for automated dynamic creation of customized media comprising the steps of:
a) obtaining information from consumer through interactive electronic communications;
b) analyzing said information to determine a profile of said consumer; and
c) producing customized media in accordance with said profile.

2. The method of claim 1 wherein said step of obtaining information comprises presenting a series of predetermined questions to said consumer.

3. The method of claim 1 wherein said step of analyzing said information comprises correlating said information obtained from said consumer with statistical information determinative of marketing profiles to determine said consumer profile.

4. The method of claim 1 wherein said step of producing customized media comprises generating said media utilizing digital variable printing.

5. The method of claim 1 further comprising, prior to step (c), the step of producing a report of said consumer's profile as it relates to the preferred style for said media.

6. A system for automated dynamic creation of customized media comprising:
(a) a database of statistical marketing information;
(b) a predetermined list of questions useful in eliciting information from a consumer regarding marketing preferences;
(c) means for comparing answers to said questions with said database to determine a consumer's marketing preferences; and
(d) means for producing customized media in accordance with said consumer's preferences.

7. A computer program product for automated dynamic creation of customized media comprising computer readable code for obtaining information from consumer through interactive electronic communications; analyzing said information to determine a profile of said consumer; and producing customized media in accordance with said profile.

8. The computer program product of claim 7 wherein said product is accessible through a global communication network.
